(19) United States
(12) Patent Application Publication
(10) Pub. No.: US 2011/0112970 A1
(43) Pub. Date: May 12, 2011

(54) SYSTEM AND METHOD FOR SECURELY MANAGING AND STORING INDIVIDUALLY IDENTIFIABLE INFORMATION IN WEB-BASED AND ALLIANCE-BASED NETWORKS USING A TOKEN MECHANISM

(75) Inventor: Yi-Cheng Yu, Taipei (TW)

(73) Assignee: Advanced Business Services Corporation, Road Town (VG)

(21) Appl. No.: 12/950,035

(22) Filed: Nov. 19, 2010

Related U.S. Application Data
(63) Continuation-in-part of application No. 12/614,209, filed on Nov. 6, 2009.

(51) Int. Cl. G06F 21/00; G06Q 50/00; G06Q 40/00

(52) U.S. Cl. 705/51; 705/2; 705/35

(57) ABSTRACT

Embodiments of a secure method to access a de-identified database on a website are described. A dual-portal web-based system is implemented that provides healthcare related information to healthcare users through a first website, and registry/management tools to care providers through a second website. No identifiable fields relating to the user are stored or accessible in the database of the first website. All user information is de-identified by total exclusion from the database. A re-identification process allows an authorized care provider view his or her clients in combination with registered personal information from the system. An alliance-based identification (ABID) key is used to index both the individually identifiable information and the personal health data/information that are stored in separate databases. A token generation process generates tokens that allow different ABID keys to be generated for use with different care providers through a single user account.

### CROSS-REFERENCE TO RELATED APPLICATIONS

The current application is a continuation-in-part application of U.S. patent application Ser. No. 12/614,209, filed on Nov. 6, 2009 and entitled “System and Method for Securely Managing and Storing Individually Identifiable Information in Web-based and Alliance-based Networks,” which is hereby incorporated by reference in its entirety.

### TECHNICAL FIELD

Embodiments relate generally to information networks, and more specifically to securely managing and storing individually identifiable information in web-based network environments.

### BACKGROUND

Various websites have been developed to allow people to log and manage their personal information in varieties of different applications, such as health care and medical information, financial data, home energy consumption, and the like. When people subscribe to these websites, they are usually required to provide certain items of Identifiable Individual Information (denoted “III”), such as their real name, home address, telephone number, social security number, credit card number, and other sensitive information. Website providers generally take efforts to protect the privacy of these users of the web service. However, as long as this type of III exists in the database of the website, it is always in danger of being stolen or corrupted by malicious users or third parties (e.g., hackers), or the website provider itself.

A particularly relevant application involving the vulnerability of the use of III in a networked environment is the health care field, in which a person keeps all of their health information on a healthcare-related website so that they or a healthcare provider can track their health status. In such an environment, several parties, such as insurers, doctors, pharmacists, and so on, may have access to at least a portion of a person's records and their III. Since the personal health information is highly confidential, the user of the web service may hesitate to subscribe to the website if the website provider cannot adequately guarantee the safety and privacy of his or her III and health information, collectively referred to as Personal Health Data (“PHD”).

FIG. 1A illustrates a conventional method of managing PHD, as practiced in many known prior art situations. The scenario of FIG. 1A illustrates the case of managing PHR in a non-networked environment, and in which an individual keeps his own personal health information 104 in any form he so desires, such as by personal notebook, receipt files, or any similar system. When the person visits a doctor, the doctor creates and keeps the individual's personal identity (III) and his medical historic data/information (MHD) 102 in a paper chart or an electronic Clinical Information System (CIS) or Hospital Information System (HIS). This information, the III and the MHD are separately maintained and owned by the two parties, the individual 103 and the doctor 101, and are isolated and have no interchange or interoperability, as shown in FIG. 1A.

To alleviate the problems associated with maintaining two separate sets of health records, one of which, namely the user's, is typically very informal and often incomplete, online systems were developed to help doctors and patience maintain a single healthcare record. The World Wide Web (hereinafter, the “web”) has become a suitable platform for implementing aspects of the health care industry, such as in the transacting or delivering of health care services on-line. A significant number of hospitals and clinics throughout the world provide services to clients on various web sites for services such as, on-line counseling, remote monitoring of vital signs or virtual visits for refill of medications. Healthcare users can contact web sites to obtain specific health information, to appoint healthcare services being offered by a particular institution, or to transmit information from Personal Health Records (“PHR”) to care providers. Likewise, healthcare providers (e.g., physicians) can utilize website based registry tools for disease management decision support, and forwarding clinical information from the electronic medical records to a clients' PHR.

FIG. 1B illustrates a conventional online method of managing personal healthcare data, as presently known, and as implemented using common web-based systems. For the system shown in FIG. 1B, a web service provider 110 provides a platform where both the individual 123 and the doctor 121 can monitor the health status of the individual. In this system, the doctor 121 maintains a CIS or HIS System 122 that stores the individual's health records 124 that consist of medical records plus the individual's III in an online database. The online database is implemented on the platform 120 that allows the user 123 to access his or her health records through a basic security system, such as password or subscription system. This system, however, remains vulnerable to attack by third parties, and thus, privacy and security remain critical concerns in such a system.

Through consumer expectations and legislation, it has become necessary for entities that store records containing identifiable personal information to secure the information so that it is not readily available to those users who do not need access to the information. For example, in 1996, the United States enacted legislation known as the Health Insurance Portability and Accountability Act (HIPAA) to impose strict privacy rules on the insurance and health care industries to protect internet users from misuse and unapproved dissemination of their personal information. Additionally, most modern websites use state of the art techniques to ensure the confidentiality of the data/information stored on their sites as well as data/information transferred over the Internet. In spite of these efforts, personal information is not always absolutely secure. With regulations such as HIPAA, which is intended to help protect a patient's privacy in their medical records, the issue of on-line privacy has become of paramount importance when dealing with highly sensitive information such as personal medical records.

Besides sensitive health related information, Personal Health Records also contain individual identifiable information, which may be considered sensitive in its own right, due to concerns such as identity theft, and the like. FIG. 1C illustrates a database structure in a current Personal Health Record system. The example database structure of FIG. 1C includes nine separate records for nine different patients. Each record contains one or more fields for the individually identifiable information for each patient (denoted III-n, where n=1-9 in FIG. 1C). Each record also contains one or more fields for the health record information for each patient (denoted HR-n, where n=1-9 in FIG. 1C). As can be seen in the database structure of FIG. 1C, the records for each patient includes both the III and health record information in a single record structure. Although the records may be encoded or protected by security measures, the presence of patient III and associated health record information all within the same database represents a point of vulnerability of such a system.

In order to protect the privacy of patients through securing identifiable information within the database, efforts are also often made to de-identify protected identity information received or created in the course of business. De-identified records are data/information, alone or in combination with other information, that cannot readily or potentially be used to identify an individual. A company may need to de-identify a person's III so that the company may continue to search on the data/information and distribute the de-identified data/information to third parties. Such information might include contact information items such as the person's full name, address, e-mail, telephone number, social security number, and identifiable photographic images. In addition, some information about familial or social relationships identified by that association, i.e., spouse, father, mother, sister, friend, social contact, employer, etc. may also be de-identified as well. Information of this type is deemed “contextual” since it is usually unverified information and is used to provide background information important to the health conditions or diseases management of the subject. In most cases, however, a health care provider will access subject information that is individually identifiable and necessary to understand the health, medical history, life experiences, or behavior of the subject and which is relevant to the health problems being addressed. By de-identifying III, an individual's identity and personal information that may identify that individual will still need to be protected. Traditionally, companies de-identify records by stripping out all III from those records. But this is effectively just a hidden processing technique in that actual storage of all III in database table remains in existence somewhere in the system's memory. Despite all efforts to de-identify data, the data still exists and remains vulnerable to exposure and misuse.

What is desired, therefore, is a health record system, or other user-based information system that allows shared access to user information and that stores no individually identifiable information of the user so that the privacy of the user can be absolutely protected. What is further desired is a method of storing a user's information on a website without any individually identifiable data/information (de-identified in nature), and that still allows an authorized care provider to be able to access the users' data/information on that website individually and in a contextually identifiable manner.

### BRIEF DESCRIPTION OF THE DRAWINGS

Embodiments of the present invention are illustrated by way of example and not limitation in the figures of the accompanying drawings, in which like references indicate similar elements and in which:

FIG. 1A illustrates a conventional method of managing PHD, as practiced in many known prior art situations.

FIG. 1B illustrates a conventional online method of managing personal healthcare data, as presently known.

FIG. 1C illustrates a database structure in a current Personal Health Record system.

FIG. 2 illustrates a computer network system that implements one or more embodiments of a system for securely managing and storing de-identified user information in web-based network environments.

FIG. 3 illustrates a site map for a patient portal used to access a database storing private user information in a de-identified database structure, under an embodiment.

FIG. 4 illustrates a site map for a clinician portal used to access a database 304 storing private user information in a de-identified database structure, under an embodiment.

FIG. 5 is a flowchart that illustrates a method of registering a physician in alliance-based restricted-database access system, under an embodiment.

FIG. 6 is a flowchart that illustrates a method of creating a patient-provider health account for an alliance-based restricted-database access system, under an embodiment.

FIG. 7 illustrates the data/information structure for an example III-XML file, under an embodiment.

FIG. 8 illustrates the database structure for a PHR web server storing de-identified patient health records, under an embodiment.

FIG. 9A illustrates a flow process for generating the example re-identified health record data of FIG. 8 in response to a name-based search engine query, under an embodiment.

FIG. 9B illustrates a flow process for generating the example re-identified health record data of FIG. 8 in response to a lab result search engine query, under an embodiment.

FIG. 10 is a flowchart that illustrates an overall process of requesting and obtaining re-identified health record information in a using a de-identified database structure, under an embodiment.

FIG. 11A illustrates an embodiment for implementing a re-identification process, under a first embodiment.

FIG. 11B illustrates an embodiment for implementing a re-identification process, under a second embodiment.

FIG. 12A illustrates the re-identification of III and PHR data in response to an algorithmic search, under an embodiment.

FIG. 12B illustrates the re-identification of III and PHR data in response to a query, under an embodiment.

FIG. 13 illustrates a system for implementing a re-identification process through a patient portal, under an embodiment.

FIG. 14 illustrates a de-identified database structure utilizing a flash memory stick to provide ABID key information for access to a restricted access database, under an embodiment.

FIG. 15 illustrates the use of a token to provide access to a single user account by a plurality of healthcare providers, under an embodiment.

FIG. 16 illustrates a token generation process, under an embodiment.

FIG. 17 is a flowchart illustrating the use of a token to generate an ABID for a user in relation with a healthcare provider, under an embodiment.

### INCORPORATION BY REFERENCE

All patents and patent applications that are referenced herein are hereby incorporated by reference in their entirety.

### SUMMARY OF EMBODIMENTS

Embodiments of the current invention relate to systems and methods for securing healthcare users' privacy by using de-identified database on a website. A care alliance is formed between a patient (user) and a care or service provider. The authorized care provider processes the user's health information that is individually identifiable by a specific re-identifying way. Users can terminate the alliance any time, and the provider is no longer able to access the user's information. A system for using a de-identified database to secure users' privacy, and a method of using alliance-based III information allows care providers to process health information that must be individually identifiable, i.e., the identity of the subject is readily ascertained by the authorized care provider for on-line services. This is achieved by building an alliance among three parties: the website, the user, and the service provider who guides the user.

In an embodiment, a dual-portal web-based system is implemented that provides healthcare related information to healthcare users through a first website, and registry/management tools to care providers through a second website. No identifiable fields relating to the user, such as name, birth date, address, e-mail address, telephone/fax number, Social Security ID, relatives and employers, is stored or accessible in the database of the first website. All user information is de-identified by total exclusion from the database, rather than by merely stripping-out true identity information from database prior to exchange or usage. Any record retrieved from this database alone can never allow anyone but an authorized care provider to identify an individual. A re-identification process allows an authorized care provider to view his or her clients in combination with registered personal information from the system. The re-identification process is enabled through the use of an ABID (alliance-based ID) key that associates the de-identified data with the fully identifiable user data. When accessing user information in the registration pages of the second website, the system enables fully identifiable personal information to be displayed in sufficient detail as well as the de-identified health data/information from the first database. In an embodiment, the re-identifying process is limited to a session-specific protocol so that the identity related dataset can only store temporarily information in the system's Random Access Memory (RAM) during the login-to-logout time interval of a successful authentication session of a care-provider.

In an embodiment, a token generation process generates tokens that allow different ABID keys to be generated for use with different care providers through a single user account.

### DETAILED DESCRIPTION

In the following description, numerous specific details are introduced to provide a thorough understanding of, and enabling description for, embodiments of the web-based secure and private personal information management system in applications such as the healthcare industry. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

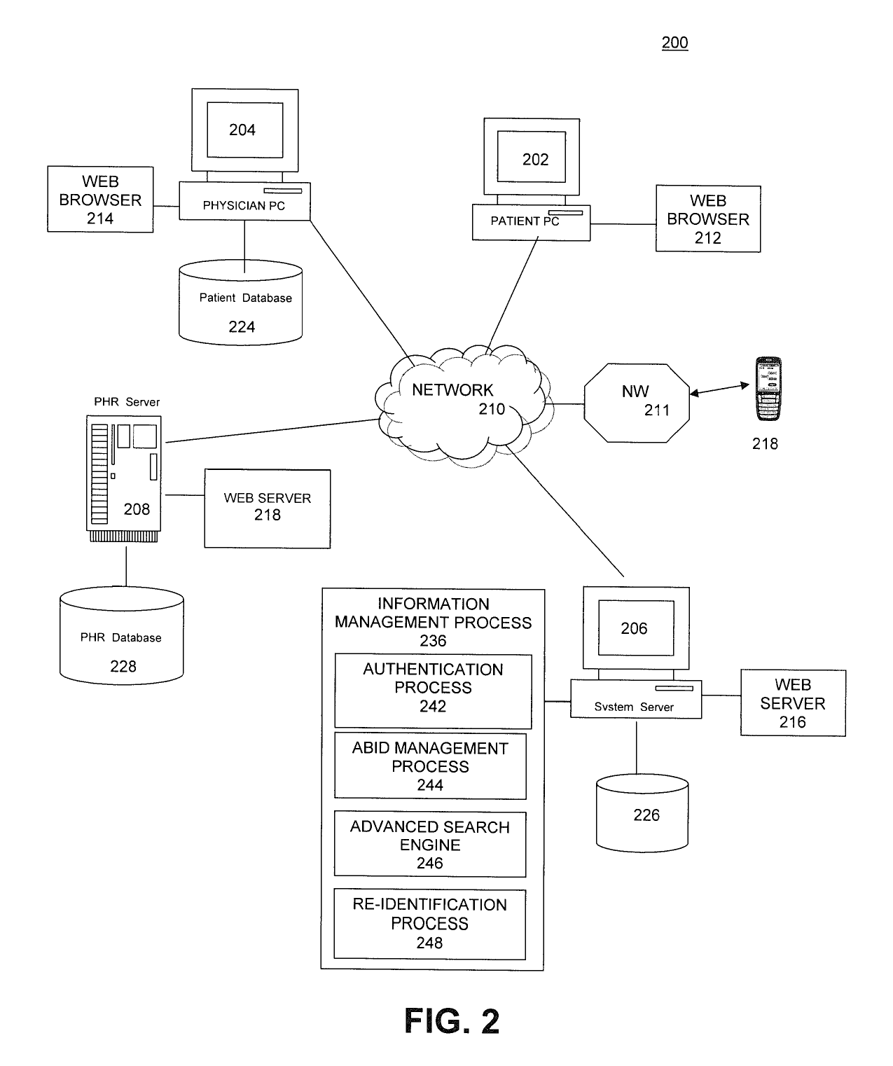

Aspects of the one or more embodiments described herein may be implemented on one or more computers or computing devices executing software instructions. The computers may be networked in a client-server arrangement or similar distributed computer network. FIG. 2 illustrates a computer network system 200 that implements one or more embodiments of a limited-access database system utilizing a de-identified database structure for storage of private user information. In system 200, network server computers 204, 206, and 208 are coupled, directly or indirectly to one or more network client computers 202 through a network 210. The network interface between the server computers and client computers may include one or more routers (not shown) that serve to buffer and route the data transmitted between the computers. Network 210 may be the Internet, a Wide Area Network (WAN), a Local Area Network (LAN), or any combination thereof. The client and server computers can be any class of computing device, such as personal computer, workstation, laptop/notebook computer, personal computing device (PDA), or mobile communication or computing device, such as smartphone 218. The client computers could be coupled to network 210 directly or through intermediate networks, such as cell network 211.

In one embodiment, a user of client computer 202 is a healthcare patient who accesses one or more server computers, such as physician computer (PC) 204, to request services from the physician or care provider. Data transferred in network 200 is enabled by one or more World-Wide Web (WWW) servers that store data in the form of web pages and transmit these pages as Hypertext Markup Language (HTML) files over the Internet 210 to other server and client computers using web server processes. For this embodiment, the server and client computers typically run web browser programs e.g., web browser 212 to access the web pages served by server computers and any other available content provider or supplemental servers. The target websites served by the web servers typically contain their own content as well as hyper links to other sites or content directly served into the target web page from separate server computers. For purposes of the following description, web pages that are served to visitors may be served by a destination website from a web server computer that is accessed through one or more intermediate websites, or it may be a web page that is accessed directly on a target website by the visitor. Unless otherwise stated, it should be understood that the term “web page” may represent an entire web page, or a portion of a web page displayed on the visitor client computer. Likewise, it may represent a component of a page. In a general meaning, a web page may be any type of directed content that is served directly or indirectly from a server computer to the visitor client computer over a network.

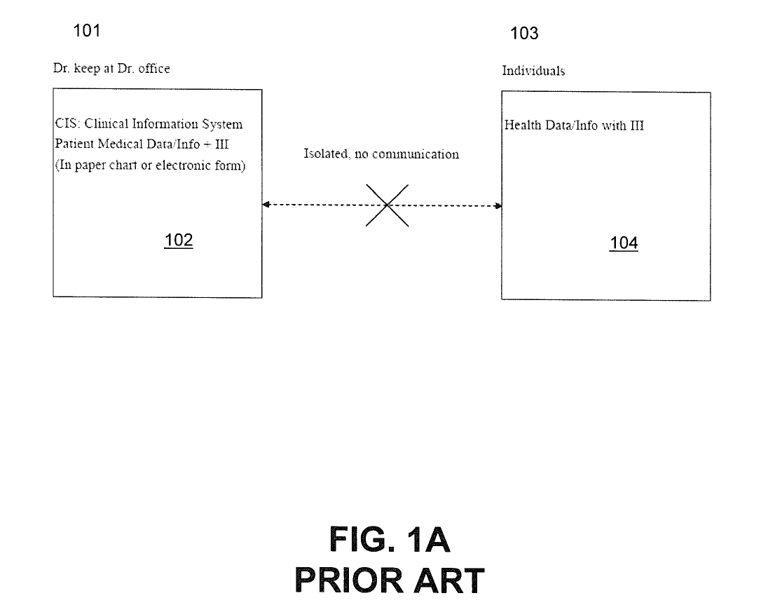

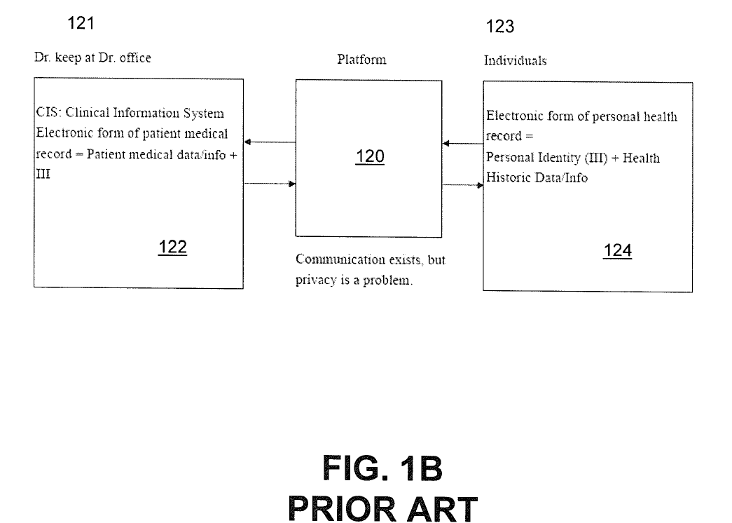

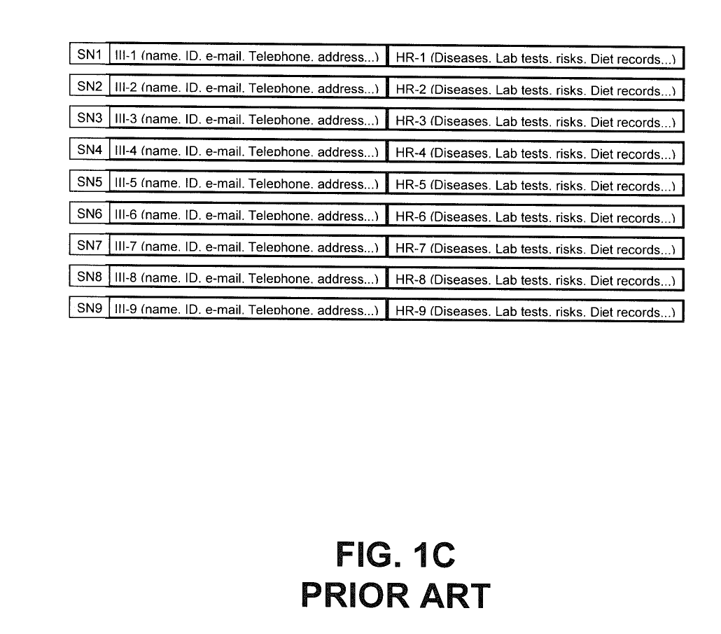

For the embodiment illustrated in FIG. 1, the PHR data for a patient is stored in a PHR database 228 coupled to PHR server 208. This PHR server may be operated by any appropriate health data management service, such as a hospital, clinic, CIS, HIS or similar entity. The physician computer 204 is maintained by a physician (or similar care provider) and III data relating to the physician's patients are stored in a patient database 224 coupled to the physician computer 204.

In an embodiment, a system server 206 in network system 200 is a server computer that executes an information management process 236. Client versions of one or more of the processes or modules for this server process may be executed on any of the physician and or the client computers 204 and 202. The information management process 236 may represent one or more executable programs modules that are stored within network server 206 and executed locally within the server. Alternatively, however, it may be stored on a remote storage or processing device coupled to server 204, 202 or network 210 and accessed by a server to be locally executed. In a further alternative embodiment, the information management process 236 may be implemented in a plurality of different program modules, each of which may be executed by two or more distributed server computers coupled to each other, or to network 210 separately. The information management process 236 includes one or more separate processes, such as authentication process 242, ABID (alliance-based ID) management process 244, advanced search engine 246, and re-identification process 248.

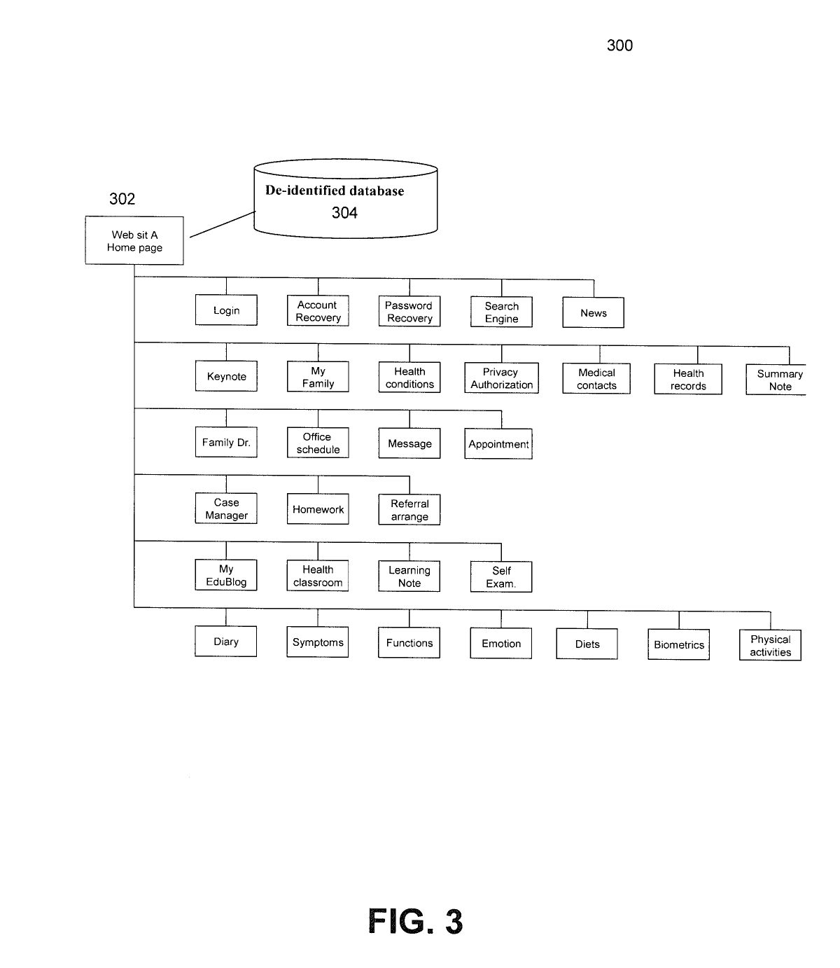

In one embodiment, the system of FIG. 2 constitutes a dual-portal alliance system architecture in which a relationship is established between the user 202 and service provider 204 to enable storage of de-identified user information in the PHR database 228. FIG. 3 illustrates a site map for a user (patient) portal used to access a database 304 storing private user information in a de-identified database structure, under an embodiment. As shown in FIG. 3, website 300 includes several different web page components including a home page 302; a login page into which a registered user can gain access to the data/information on the website; an account recovery page; a password recovery page; and a search engine which a user may use to search the website. The website 300 also includes information for disease care guidance, health risk appraisal, and drug usage which may be accessed by users to self care practice, and which can be customized based on the users' medical and navigation histories. Furthermore, the website provides recording tools for used drugs, major health conditions, lab tests, medical visits, biometrics, diets, exercises and other daily activities. There may also be provided mailbox/blog tools for inter-user communication such as receiving messages from a care provider or sending messages to care providers or clinics. With reference to FIG. 2, the website 302 is maintained by the client computer 202, and database 304 corresponds to PHR database 228.

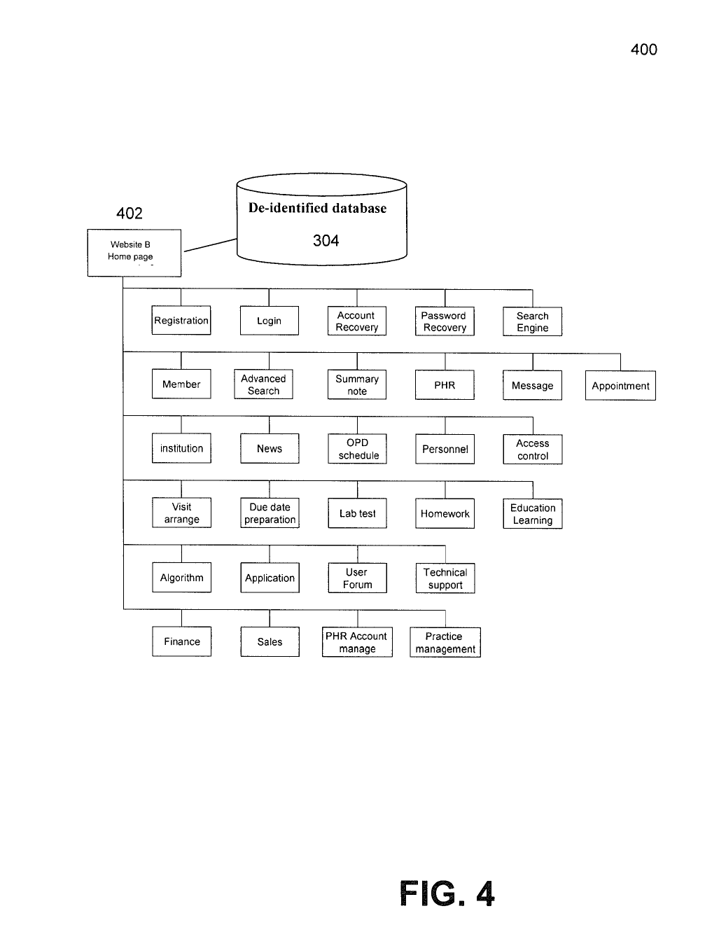

The database 304 can also be accessed by a separate website provided for the service provider (clinician). FIG. 4 illustrates a site map for a clinician portal used to access the database storing private user information in a de-identified database structure, under an embodiment. As shown in FIG. 4, the website 400 includes a home page 402 with sitemap and historical information, and membership guide for registration; a registration page which may be used by a new clinician user to register with the website; a login page into which a registered user to gain access to the data/information on the website; an account recovery page; a password recovery page; and an advanced search engine which a user may use to search the website, including target patients or target diseases with any criteria combination, such as specific demographic characteristics, medications, operation histories, conditions, laboratory results, and so on. The website also includes institution practice management information, disease introduction, planning for individual or group visits, and a desktop for practicing management such as progress view of disease, notepad for memo exchange and referral sheet between clinicians. With reference to FIG. 2, the website 402 is maintained by the physician computer 204.

Access to the PHR information for the patient that is stored in database 304 is controlled through an alliance relationship that is established between the patient and the clinician. In most circumstances, the clinician is a physician such as family doctor or general practitioner who is the principal health care provider for the patient. Alternatively, the clinician may be a specialist, consultant, pharmacist, or other care provider who provides care related to the health of the patient and who may need to access the patient's PHR information. In an embodiment, the alliance relationship is established by a physical act of the patient visiting the clinician's office or place of business and authorizing this person to managing the health, or a specific health problem for the patient. Once the alliance formed, the clinician (e.g., physician) can act as an authorized relationship based care provider and the alliance will hold the doctor accountable for health outcome. Depending upon actual insurance or business implementation, the physician may receive a yearly extra money reward from a payer (e.g., insurer), which is paid according to accountability indicators, health outcome indicators, and cost saving from virtual capitation adjusted by global budget, and other like factors.

The system includes mechanisms whereby either the patient or doctor can terminate the relationship when either party desires, such as when mutual trust is compromised or the two parties do not cooperate well with each other, or any other appropriate reason.

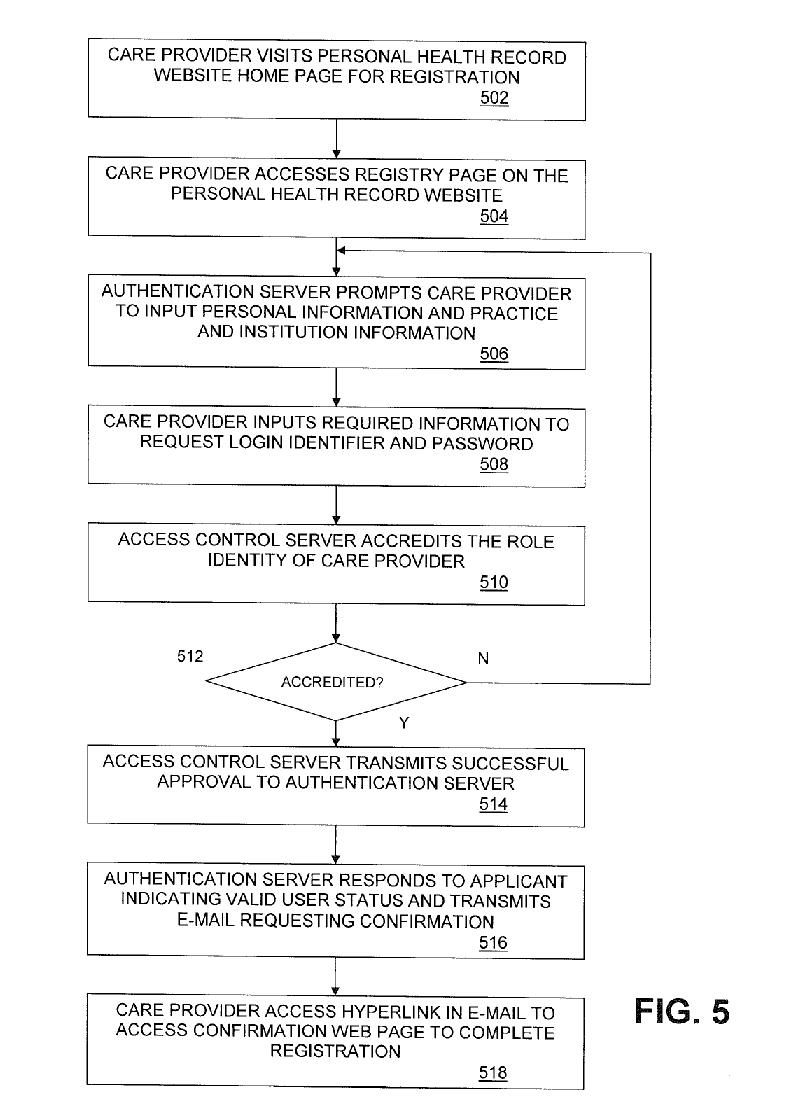

The alliance-based authorization requires registration of the physician with the system. FIG. 5 is a flowchart that illustrates a method of registering a physician in alliance-based restricted-database access system, under an embodiment. In block 502 the care provider visits the homepage of website 402 for the clinician portal to register him or herself to access the personal health records stored in the database 304. The care provider accesses a registry page on the website 402, block 504. Through this registry page, the system authentication server prompts the care provider to input certain personal information about the care provider, as well as information about his or her practice and any institutional information, block 506. In block 508, the care provider inputs this required information in order to request a registration login identifier and password. In an embodiment, the care provider information includes a provider identifier, a nation identifier to indicate the country in which the provider is located, an area identifier to indicate the city or area in which the provider is located, and an institute identifier to indicate the institution, such as hospital, clinic, or university, that the provider is employed by or associated with. The provider information can be coded in a string composed of fields for each identifier, such as in the following form: |DrID|Nation ID|Area ID|Institute ID|. The size and format of this identifier string can be configured in any appropriate manner depending upon the constraints and requirements of the system.

Upon input of the required information, the access control server accredits the role identity of the care provider, block 510. The accreditation decision is performed in block 512. If the provider is not accredited, such as due to erroneously entered information or lack of appropriate credentials, the care provider is re-prompted to enter the information from block 506. Upon successful accreditation, the access control server transmits a successful approval message to the authentication server, block 514. The authentication server responds to the applicant indicating a valid user status and transmits an e-mail message to the provider requesting confirmation, block 516. The e-mail message may include the login identifier and password for the provider to use. In block 518, the provider accesses the web page referenced by a hyperlink in the e-message and inputs the appropriate login identifier and password to complete the registration.

The alliance based authorization process thus allows the provider to access the website of clinician portal by presenting a unique ID and password. The provider then makes a request to create a PHD account via clinician portal for his or her patient.

The provider registration process of FIG. 5 implements certain security mechanisms within the HTTP (Hypertext Transport Protocol). These include, but are not limited to, a Transport Layer Security (TLS) and its predecessor, Secure Sockets Layer (SSL), to provide user endpoint authentication and communication privacy over the Internet using cryptography. The system also requires that the level of identification assurance at the website must be at least as high as the entity registered. The successful authentication permits access the health data/information access only by express authorization of the patient of the specific alliance with the provider. A role-based access control mechanism is defined by system to limit the extent and the way the provider can access the PHR database 304.

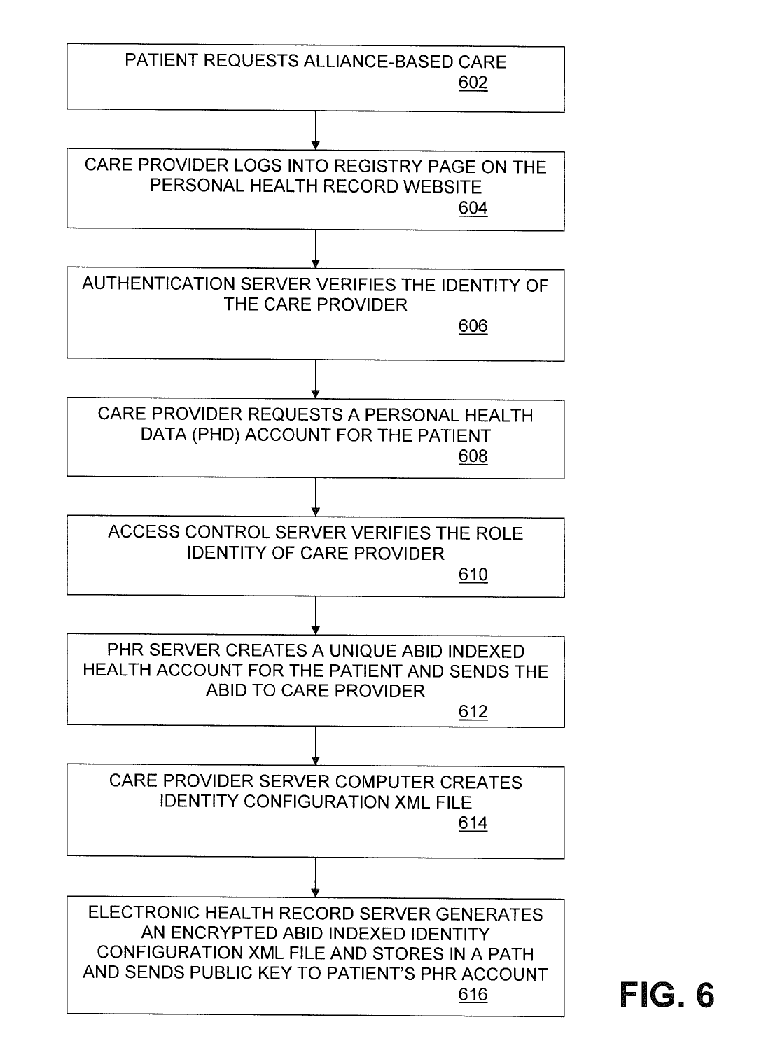

Once an alliance-based relationship is established between a provider and a patient, a health account is created within the system for this patient-provider alliance. FIG. 6 is a flowchart that illustrates a method of creating a patient-provider health account for an alliance-based restricted-database access system, under an embodiment. As shown in FIG. 6, this process is initiated by the patient requesting alliance-based care from the provider whom he or she previously authorized, block 602. To provide this care, the provider will ostensibly need to access certain PHR information for the patient. As shown in block 604, the care provider logs into the registry page on the PHR website 402. The authentication server verifies the identity of the provider, block 606. The care provider then requests a personal health data (PHD) account to be created for the patient, block 608. The access control server verifies the role identity of the care provider through one or more of the security mechanisms, such as the role-based access control mechanism, block 610.

Once the provider who has logged on is proven valid through successful authentication and the other security mechanisms, the request for creating PHD account is sent to an algorithmic rule server to create an ABID-indexed PHD account in the database 304. The data/information in the PHD account is totally de-identified, that is, any information that serves to identify the patient, such as name, birth date, address, e-mail address, telephone/fax number, Social Security ID, relatives and employers, will not be present and/or stored in the database. As shown in block 612 of FIG. 6, the PHR server 208 creates a unique ABID-indexed health account (PHD account) for the patient and transmits the ABID key to the care provider, block 614. The care provider server computer 204 then creates an identity configuration XML (Extensible Markup Language) file for the provider. This identity configuration XML comprises the provider identifier consisting of the following information: |DrID|Nation ID|Area ID|Institute ID|.

The Electronic Health Record (EHR) server generates an encrypted ABID-indexed identity configuration XML file and stores this in a certain path for a URL (Uniform Resource Locator) of the website, and sends a public key to the patient's PHR account, block 616. The EHR server is generally maintained by a trusted entity and stores the HI of the patient in a database that is separate from the patient PHR database 304. The EHR server may be maintained by a CIS or HIS system that may include an add-on component that enables the care provider to register his or her patients, and produce an III-XML file from certain table elements of the EHR database by which the data/information viewed by doctor will be re-identified in the care provider portal website 406. The ABID key created in block 612 is returned to the provider's website, and a contemporaneously created III-XML file is created and stored as a specific path and file name in the database 304.

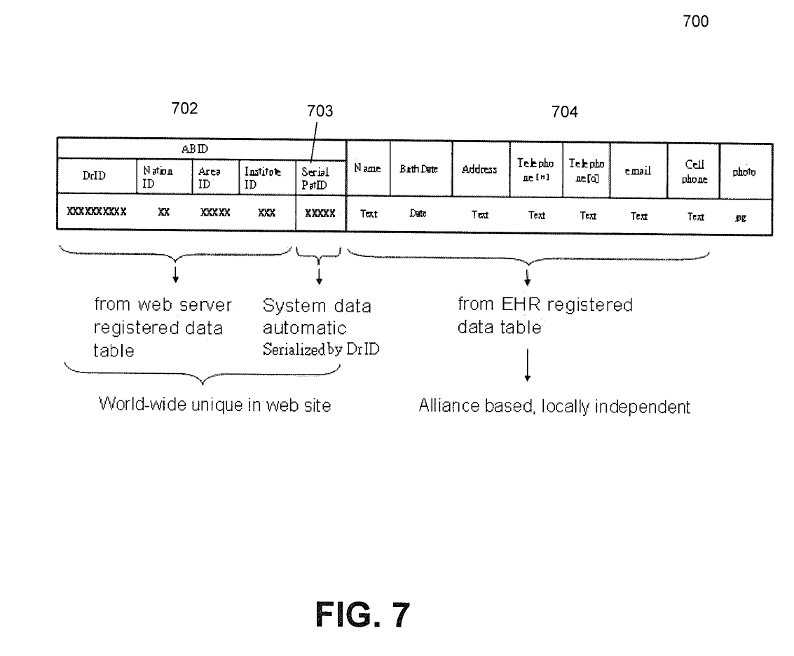

FIG. 7 illustrates the data/information structure for an example III-XML file, under an embodiment. The III-XML file 700 consists of an ABID portion 702 that includes the provider's ID code (DrID), Nationality code (NationID), area or location code (AreaID), and Institution code (InstituteID). This information is pulled from the registration information input by the provider through the provider portal website 402. The second part of III-XML file 700 is a unique serial number (Serial_PatID) 703 that is automatically generated by the system and that is specific for the alliance once it is formed. This serial number is serialized by the DrID in the ABID 702. The III-XML file also includes a third part 704 comprising the individually identifiable information III of the patient that is provided from an HER registered data table. This EHR information may be provided from selected data/information table of the clinical information system that the provider may use for CIS editing and/or storing. As shown in FIG. 7, the ABID key is critical to access the patient data. Each of the fields of the III-XML file may be alpha-numeric text strings or encoded data of various sizes and formats, depending upon system constraints and requirements. For example, the DrID field forming part of the ABID 702 may be on the order of 400-500 bytes per III-XML file. The storage requirements for III-XML files in an overall system may then be on the order of 2 megabytes for 4000 members of the system.

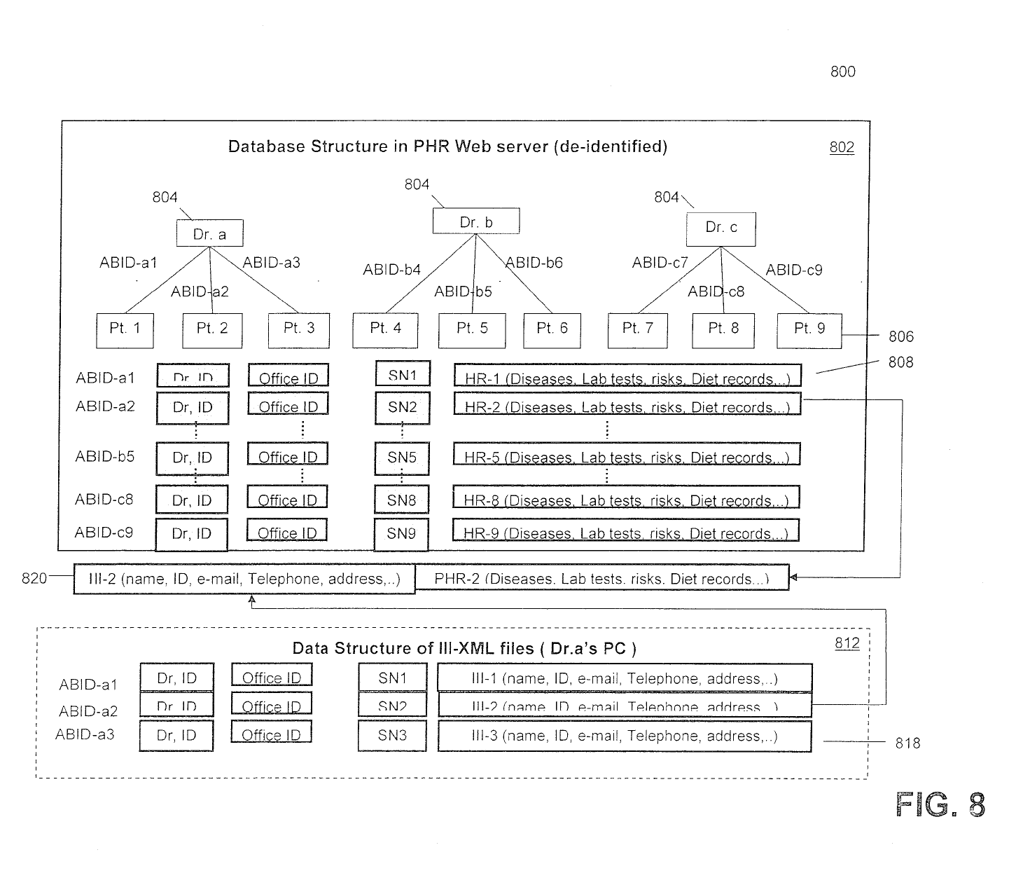

FIG. 8 illustrates the database structure 800 for a PHR web server storing de-identified patient health records, under an embodiment. FIG. 8 illustrates a database system in which several example alliances are formed among three doctors 804 denoted Dr. A, Dr. B, and Dr. C, and three respective patients 806 each, denoted Pt. 1 to Pt. 9. For each doctor-patient alliance, a separate ABID key is generated, such as ABID-a(1-3) for Dr. A, ABID-b(1-3) for Dr. B, and ABID-c(1-3) for Dr. C. The personal health records 808 for each of the patients, Pt. 1 to Pt. 9 are stored in a database structure 802 that is maintained within the PHR database 228 that is managed by PHR server 208. For the example of FIG. 8, the health records 808 for each patient are denoted HR-1 to HR-9, and list various items of medical information for each patient, such as medical background, medical history, diet records, lab test results, and so on. Each health record 808 is indexed by a respective ABID key that denotes the physician identifier (DrID), office identifier (OfficeID) and serial number (SN).

The individual identifying information (III) for each patient of a particular doctor is stored on a computer managed by that doctor. Thus, in the example of FIG. 8, the computer of Dr. A (812) stores the III objects 818 for his patients, Pt. 1 to Pt. 3. The III objects consist of information sufficient to identify each particular patient, such as name, address, telephone, birthdate, and so on. The III objects are referenced by the ABID key for each patient.

As can be seen in FIG. 8, the III information for each patient is maintained on the physician computer, while the health record for each patient is separately maintained on the PHR server database. The health record information is thus totally de-identified while it is stored on the PHR system, and cannot be associated with any particular individual patient in the event of exposure, theft, or data corruption. A re-identification process is used to associate a particular health record with the appropriate patient when requested by the authorized physician. An example re-identified health record for patient 2 of Dr. A is illustrated in FIG. 8. The re-identified health record 820 comprises the III-2 object from Dr. A's computer and the HR-2 health record from the PHR server. The II-2 and HR-2 objects that make up the re-identified health record 820 are both referenced by the same ABID key (in this case, ABID-a2). This ABID key allows both components to be associated with one another, and they can then be concatenated or otherwise served together when requested by Dr. A for display on his or her computer.

The re-identified patient data can be provided in response to several different use scenarios related to requests for information about a patient by a physician, care provider, lab, insurance company, and so on. Among the most common use cases is where a physician pulls up a patient's records in order to provide care requested by the patient, such as in a diagnostic appointment, emergency, or regular doctor visit. The authorized physician logs onto the PHR website and is validated as an authorized party to receive the re-identified patient data.

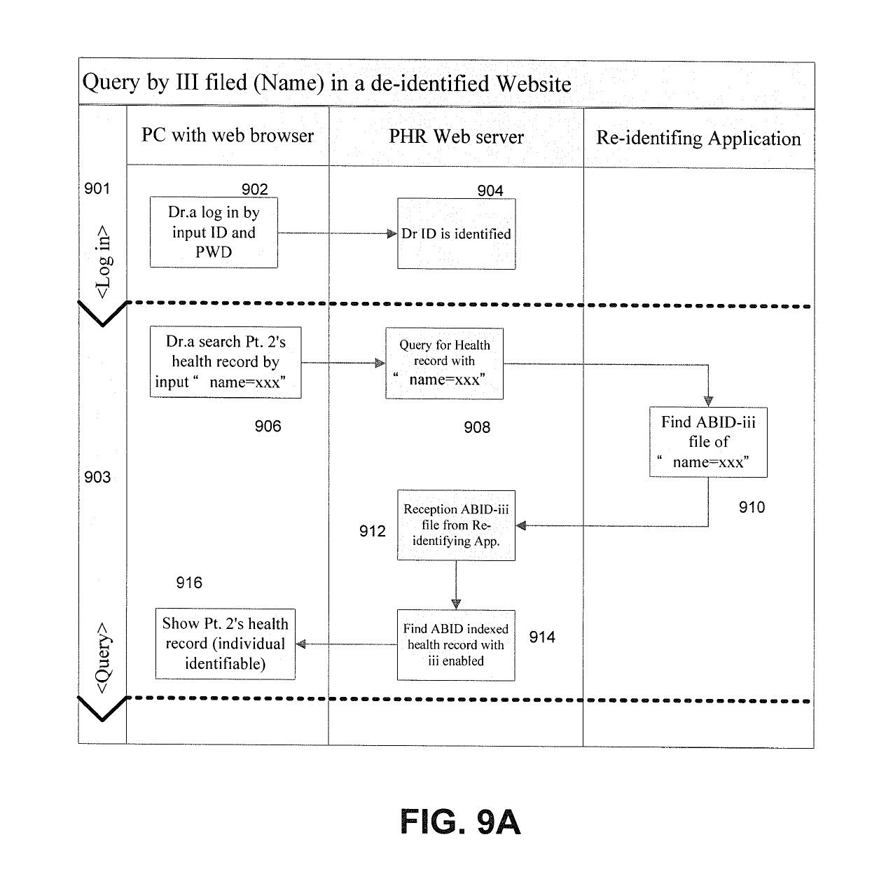

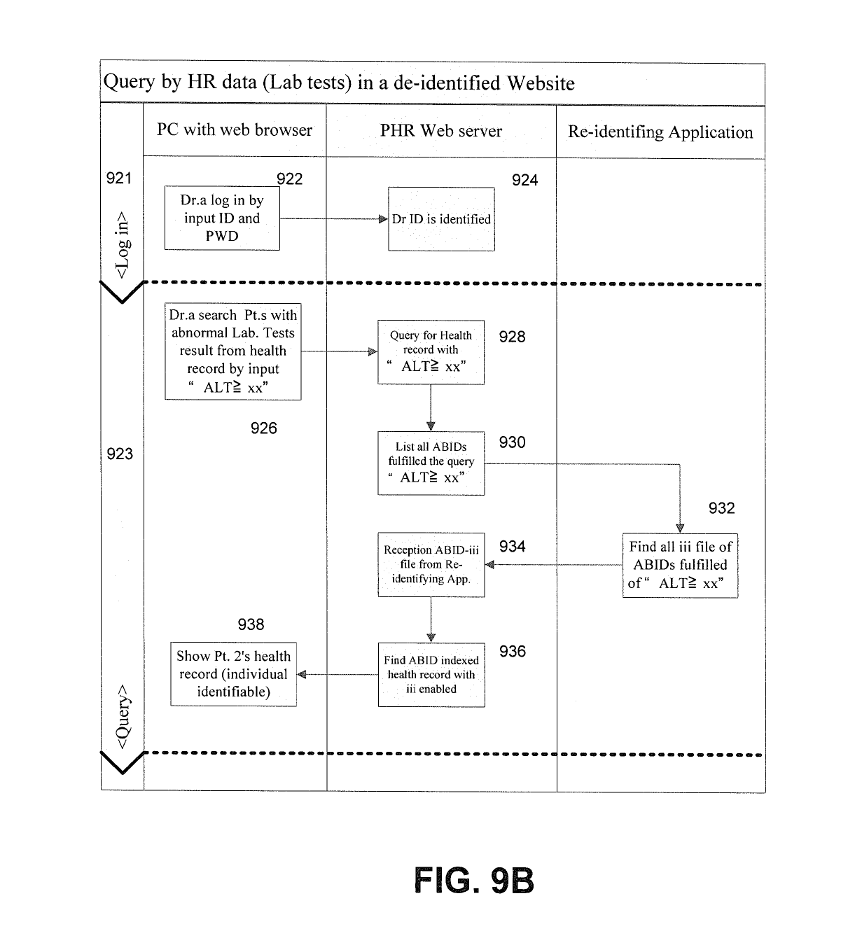

FIG. 9A illustrates a flow process for generating the example re-identified health record data of FIG. 8 in response to a search engine query, under an embodiment. The query of FIG. 9A is based on a search of the patient's name by the authorized physician using the advanced search engine 246 of system server 206. During the login process 901, the physician uses the web browser 214 on his or her computer 204 and logs into the system by inputting the appropriate ID and password, block 902, and the PHR web server 218 validates the identity, block 904. During a query process 903, the physician can perform a search for a particular patient's (e.g., Patient 2) health records by entering the patient name in the appropriate search engine field, block 906. The PHR web server 218 parses the query for health record(s) containing the searched for name, block 908. In block 910, the re-identification process 248 finds the ABID-III file corresponding to the searched-for patient by decoding the ABID key based on the inquiring physician's login information. The PHR server then receives the ABID-III file from the re-identification process, block 912. The PHR web server uses the same ABID key to retrieve the health record for the searched-for patient, block 914. The health record and the III information is then combined for display, typically as a single record, for display to the physician on his web browser, block 916. Such a combined record for this example of Patient 2 (Pt. 2) is illustrated as object 820 in FIG. 8.

The advanced search engine 246 can be configured to allow various different types of searches of PHR information related to many different aspects of health care. Searches by patient name are common, but other types of searches are also possible, such as by location, date of birth, medications, diseases, and the like. FIG. 9B illustrates a flow process for generating a re-identified health record data in response to a lab-test based search engine query, under an embodiment. The query of FIG. 9B is based on a search of any and all patients that have specific lab test results. To perform the query, the physician first logs in through process 921 using the web browser 214 on his or her computer 204 to input the appropriate ID and password, block 922. The PHR web server 218 then validates the identity, block 924. During a query process 923, the physician can perform a search for all patients that have abnormal lab test results by entering the search string (e.g., “ALT=xx”) in the appropriate search engine field, block 926. The PHR web server 218 parses the query for health records containing the searched for string, block 928. The PHR web server then lists all ABID keys that fulfill this search query, block 930. In block 932, the re-identification process 248 finds all III files of ABID's corresponding to the searched-for lab results by decoding the ABID key based on the inquiring physician's login information. The PHR server then receives the ABID-III file or files from the re-identification process, block 934. The PHR web server uses the same ABID key to retrieve the health record for the patients referenced by the ABID-III file, block 936. The health record and the III information is then combined for display, block 938.

The de-identified database system is generally accessed by a physician or other care provider logging onto the PHR website, and validating himself by inputting the registered ID and password. Using the advanced search engine 246, the physician can request the health records of specific patients or conditions. The ABID management process 244 creates all ABID indexed de-identified health accounts that match the search criteria. The ABID file is transmitted to the physician computer, which then calls a web service to get the III-XML file for the defined target population, which is then transmitted to the physician computer 204.

A physician accessing the PHR server for the first time will need to register to before being acknowledged as a validated member. For security reasons, the PHR database 228 provides only de-identified information, and the physician will need to obtain the patient's III information from a separate source else or from his or her own computer 204. A re-identification process 248 uses the ABID indexed III records and the PHR data to form combined ABID-III records for the physician.

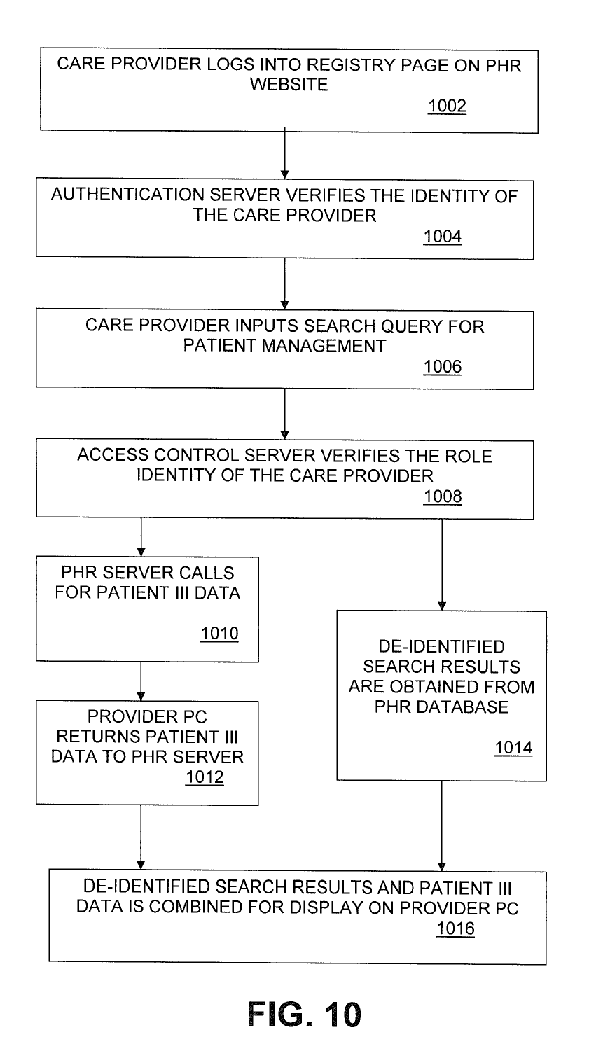

FIG. 10 is a flowchart that illustrates an overall process of requesting and obtaining re-identified health record information in a using a de-identified database structure, under an embodiment. The illustrated method is an example of a physician contacts a PHR website to access a de-identified account information, and how search results are associated with patient III data stored elsewhere the ABID key for re-identification and display through the physician computer web browser. In the method of FIG. 10, the physician or other care provider logs into the registry page of the PHR website, block 1002. The authentication server then verifies the physician by validating the input ID and password, block 1004. Once verified, the physician can input the search query for the patient management task, block 1006. This can consist of a search for a particular patient by name, condition, or other search parameter. The result of the search will be the health record of a particular patient or patients. To process the requested search, the access control server verifies the role identity of the physician, block 1008. After the role identity is verified, the separate patient PHR data and patent III information is obtained. As shown in block 1014, the patient PHR data, which is de-identified and does not include any III information is obtained from the PHR database. Concurrently, the separate patient III data is called by the PHR server, as shown in block 1010. The patient III data may be stored in the physician computer, or another database that is separate from the PHR database that stores the patient PHR information. The physician computer or other database returns the patient III data to the PHR server, block 1012. The de-identified PHR information that is retrieved in response to the search query is then combined with the returned patient III data for display on the physician computer, block 1016. The PHR data is and III information are both indexed by the ABID key that is generated for the physician.

Under an embodiment, a re-identification process serves to associate the III information with the health record information for a specific patient and in response to a particular query or other fetch process. The re-identification process can be implemented in various ways depending upon the actual network and system configuration. For example, the re-configuration may be implemented as a software process executed on the care provider computer, or a separate network server computer, or it may be implemented as a hardware component or apparatus coupled to the network.

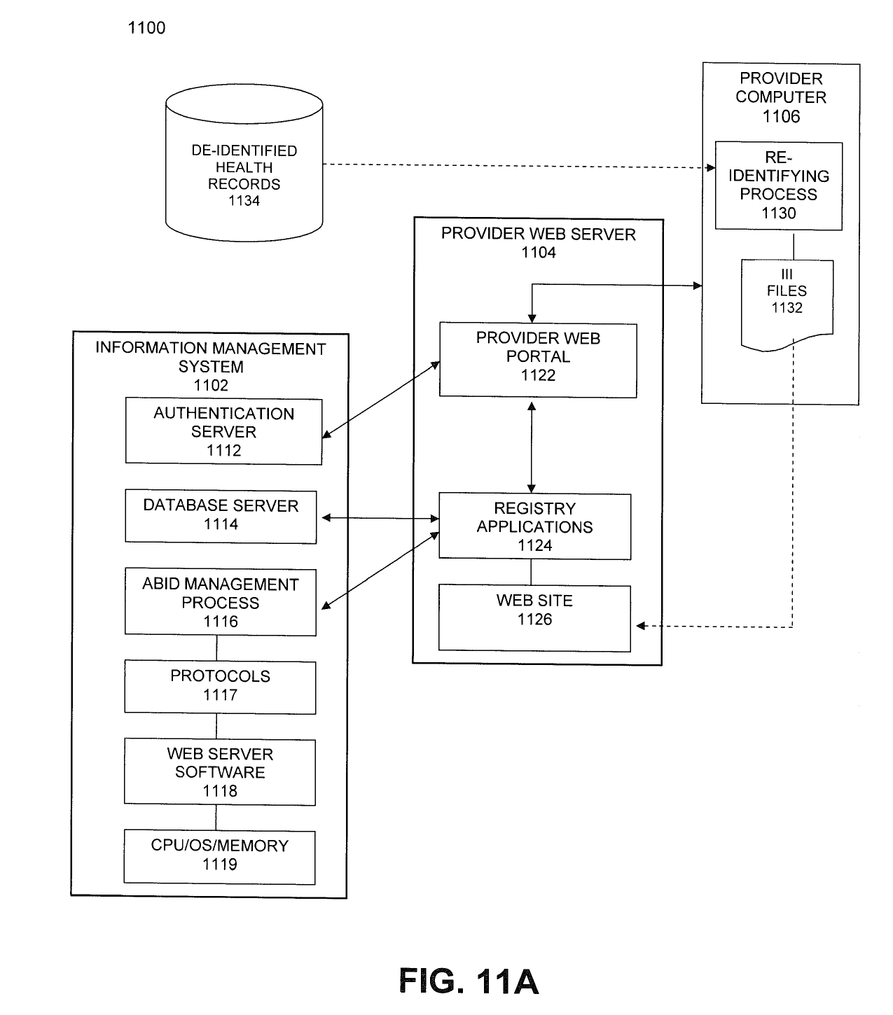

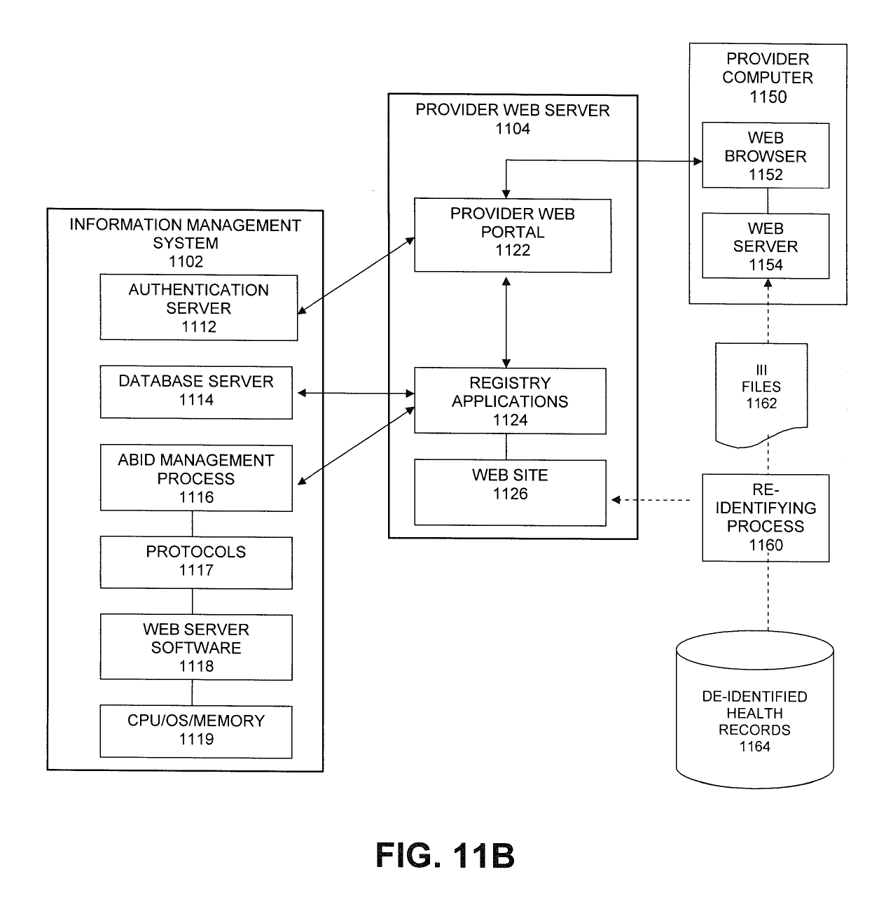

FIG. 11A illustrates an embodiment for implementing a re-identification process, under a first embodiment. In this embodiment, the provider computer 1106 stores the patient III files 1132 locally or in a closely-coupled database, and executes a local re-identifying process 1130. An information management system 1102 including an authentication server 1112, a database server 1114, an ABID management process 1116, a network protocol server 1117, web server software 1118 and other components 1119, such as process, operating system, and memory (e.g., RAM/ROM) is functionally coupled to a provider web server 1104. The web server 1104 includes a provider web portal 1122, registry applications 1124 and serves a website 1126. The information management system 1102 controls the authentication of the provider through the authentication server 1112 interaction with the provider web portal 1122. The registry applications 1124 controlled by the provider web portal 1122 interact with the ABID management process 1116 to generate the ABID keys that allows the re-identification process 1130 to associate corresponding III files 1132 with the de-identified health records 1134 to produce the re-identified health record that is displayed through the provider web site 1126. For the embodiment of FIG. 11A, the provider computer stores the III and has installed the re-identifying software component. Corresponding software for requesting a re-identified health record may be auto-running on the web server 1104. This allows a provider logging into the system remotely on any PC to access not only the de-identified web information but the individually identifiable data browsed in addition.

FIG. 11B illustrates an embodiment for implementing a re-identification process, under a second embodiment. In this embodiment, the provider computer stores the III file in a computer for which a web server set-up for responding to a re-identifying request from a second website server when the provider logs into the system anywhere on any PC using registry applications. At the same, the provider will access not only the de-identified web information but the individually identifiable information browsed in addition. For the embodiment of FIG. 11B, the provider computer 1106 includes a web browser component 1152 and a web server component 1154 and accesses patient III files 1162 that may be stored locally or in an external or closely-coupled database. An external re-identifying process 1160 is used to access the de-identified health records from database 1164. An information management system 1102 including an authentication server 1112, a database server 1114, an ABID management process 1116, a network protocol server 1117, web server software 1118 and other components 1119, such as process, operating system, and memory (e.g., RAM/ROM) is functionally coupled to a provider web server 1104. The web server 1104 includes a provider web portal 1122, registry applications 1124 and serves a website 1126. The information management system 1102 controls the authentication of the provider through the authentication server 1112 interaction with the provider web portal 1122. The registry applications 1124 controlled by the provider web portal 1122 interact with the ABID management process 1116 to generate the ABID keys that allows the re-identification process 1160 to associate corresponding III files 1162 with the de-identified health records 1164 to produce the re-identified health record that is displayed through the provider web site 1126.

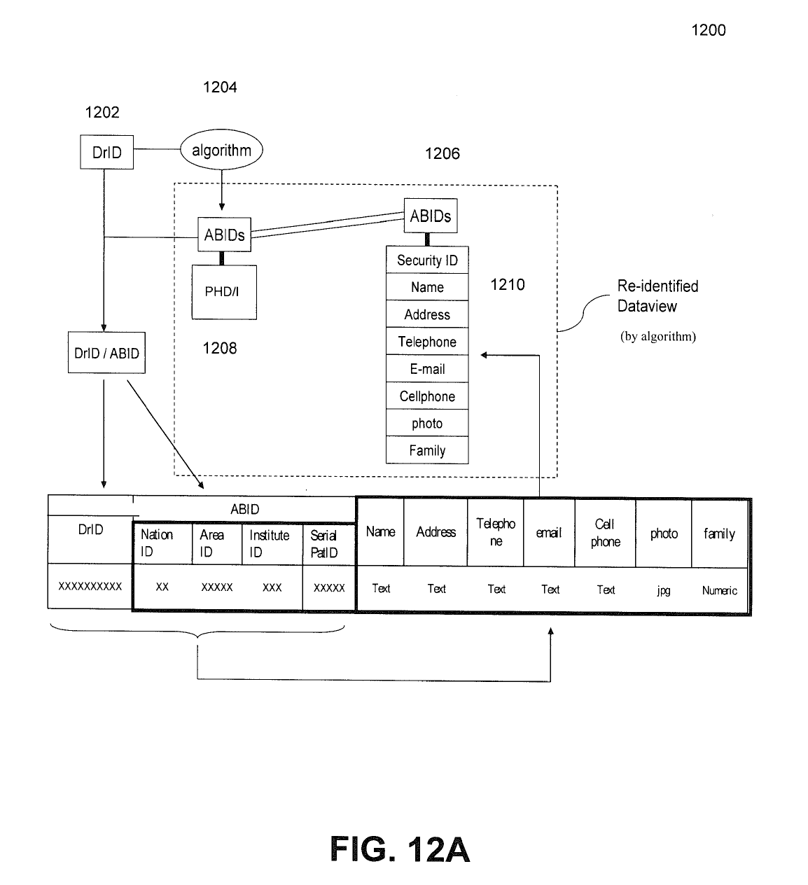

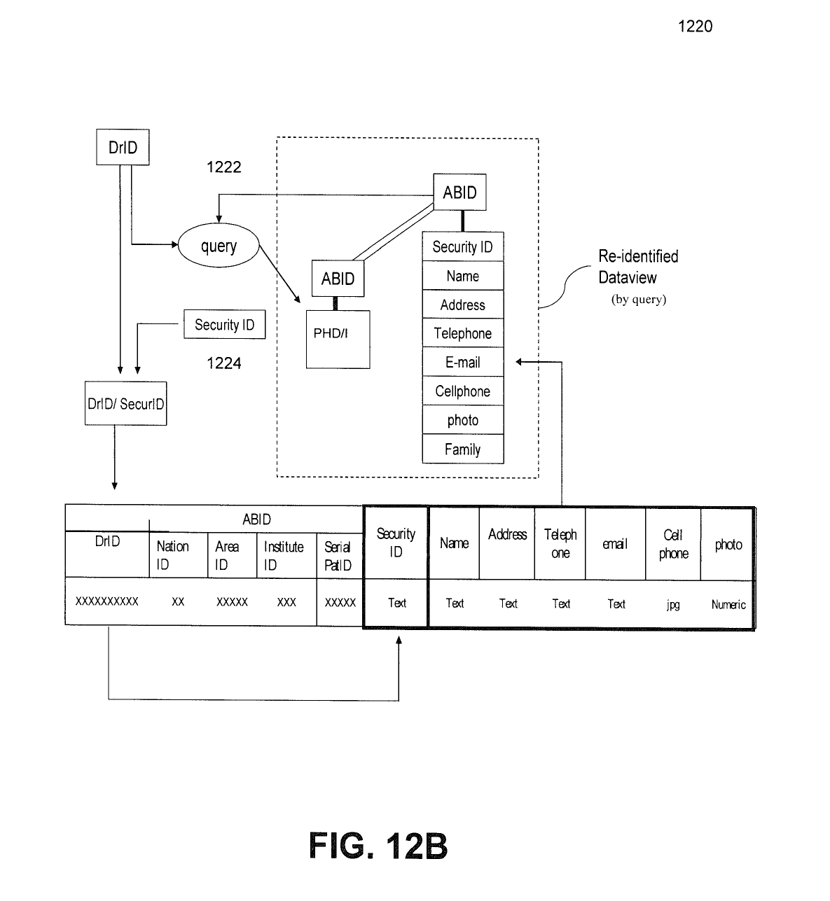

As stated above, the ABID key is the mechanism by which the III information for a patient is associated with the health record data for that patient. An ABID management process 1116 generates the ABID key based on the provider data. The re-identification process uses the III indexed by an ABID key to associate the corresponding health record data for display on the provider computer. In an embodiment, the re-identification process may be initiated by an algorithmic search, or by a query. FIG. 12A illustrates the re-identification of III and PHR data in response to an algorithmic search, under an embodiment; and FIG. 12B illustrates the re-identification of III and PHR data in response to a query, under an embodiment. As shown in FIG. 12A, the DrID object 1202 is processed by an algorithm 1204 that generates an ABID key 1206 that accesses the personal health information (PHD/I) 1208, and the separately stored III file 1210 for the patient. The re-identified dataview comprises both the III file and the PHD/I information displayed together in the provider's computer. For the query-based embodiment of FIG. 12B, the DrID object and the ABID key are processed by the query process 1222 to access the PHD/I for the patient. A separate security ID component 1224 is also used to form part of the re-identified data view of the patient health record.

As shown in FIG. 2, the user (patient) of the network system can access the network 210 through their own client computer 202, which runs a web browser 212. Through this web interface, the healthcare user can contact the physician or provider website 214 to obtain specific health information, to appoint a doctor, or request healthcare services being offered by a particular institution, or to transmit personal health information (PHD/I) to care providers and so on.

Embodiments of the system allow the re-identifying of information that can be displayed to the healthcare users. In this case, re-identification processes can be implemented in the client computer 212 or in a component (apparatus or software process) accessible to the client computer. In this manner, the de-identified health record information can be joined with the corresponding ABID-indexed III information that may be provided back from the provider's database. This arrangement allows the health care users to update their personal information related to the patient III data.

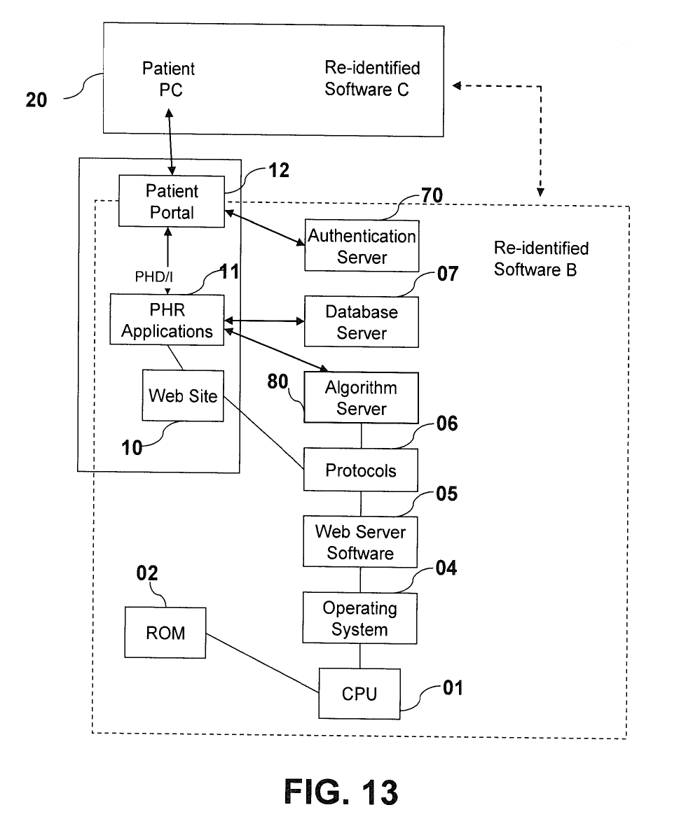

FIG. 13 illustrates a system for implementing a re-identification process through a patient portal, under an embodiment. As shown in FIG. 13, the patient client computer 20 accesses a patient portal 12 that includes PHD/I (Personal Health Data/Information) applications 11, and a website 10. The various server processes of the information management system serve to associate the III information with the PHD/I information to form the re-identified data that is displayed through the web browser of the user client computer. In this system, when the authorized care provider uses his or her web browser to access the website for management utility, the III files stored in their computer will stay up-to-date once a client modifies the data/information.

The de-identified database structure and restricted access patient database described herein provides robust and efficient protection of private patient data through mechanisms that include: enhancing the authentication by software applications or hardware devices; de-identifying health data/information by anonymous exchange during transaction; encrypting and decrypting the data/information by public-to-private key pairs; and linking users' computer in a close network (e.g. virtual private network, VPN) as a trusted delivery networks while maintaining privacy through security procedures and tunneling protocols. A first database stores the existing identifiable data/information fields in related table, such as name, address, birth date, e-mail, telephone number, social security number, among others. This is the information within most systems that is vulnerable to theft or unauthorized dissemination or access of personally sensitive private health data/information. This information is protected by its exclusion from any database that contains health record or other data related to the patient. That is, the substantive health record information is stored in a second database that is separate from the first database. Only authorized care providers specified by the healthcare user is allowed to view and manage the patient's health data/information with corresponding III data/information.

An ABID key mechanism is used to index the III and health data information and is used by a re-identification process that joins or combines these two components of data for display to the provider and/or user. The re-identifying process involves at least two different internet protocols to support the full data view in the care provider web browser.

Although embodiments have been described with respect to a web-based implementation, other systems incorporating an ABID key and a re-identification process acting on III and PHD/I information stored in two separate databases can be implemented on other platforms. For example, a USB flash memory device, or similar portable, persistent memory device can be used to transfer relevant data. In this embodiment, a website provides the web service that a person could put his health related info/data on the server of the platform but that does not include any III. A physician also subscribes to the website and receives a memory stick to store III of the patient. When the patient visits the physician, the physician logs in to the web service account and adds the person into his management list, and the alliance is built between the person and the physician. The III of the person, which is stored in a CIS or HIS system will be downloaded into the memory stick. An ABID key will then be generated by the website and stored in the memory stick (the key box) and the III can be addressed by the key (ABID) in the key box.

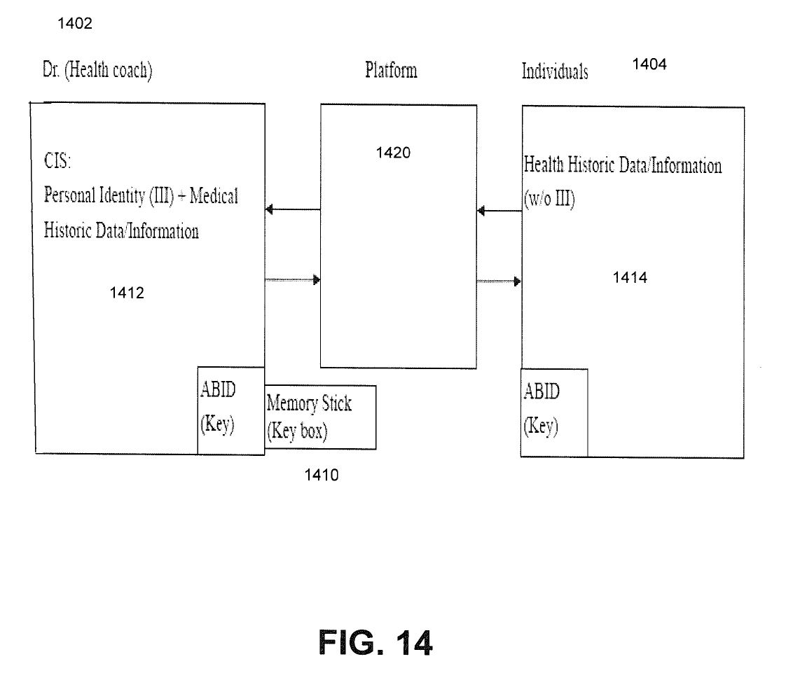

The person could see his own health information/data without III on the website. By opening the key box through a password of the physician and the memory stick, and using the ABID key, the physician can open the file that stores the III file addressed by the ABID. This allows the physician to search the health data/information which belongs to the person. A re-identification process combines the two separate III and PHD/I parts together to produce a completed identifiable personal health record (PHR) for the physician. FIG. 14 illustrates a de-identified database structure utilizing a flash memory stick 1410 to provide ABID key information for access to a restricted access database, under an embodiment. In this system, when the patient 1404 visits the physician 1402 and opens account in the website, the alliance is established. The physician receives the ABID and memory stick 1410. Security is implemented through the encoding of the CIS password+Website password+USB stick+ABID through processes provided in platform 1420. The ABID key 1410 is used to access the de-identified database 1414 and to associate corresponding III information 1412, as described above with respect to the process of FIG. 10.

### Token Generation

For the embodiments described above, a user account is designated with an ABID in accordance with a healthcare provider with whom the user applies for service. The ABID offers a re-identification mechanism that allows the service provider to access the user's de-identified data from a database accessible through a website. In many cases, a user may rely on a variety of different service providers to fill various needs related to his or her total health. For example, a user may have a general practitioner or family physician as a main doctor and various other specialists to provide other services, such as pharmacists, gynecologists, pediatricians, surgeons, and so on. Each of these service providers may need to access the same body of III information, or parts of the user's III information. In an embodiment, the ABID management system includes a token mechanism which allows a user to register for different healthcare providers with a unified user account. A single user account can be designated with a plurality of ABIDs corresponding to several healthcare providers without the need of replicating and storing the data in various databases. With a single user account, the user service records and information can be shared among different healthcare providers in a way that facilitates patient-centered coordination and integration of healthcare services.

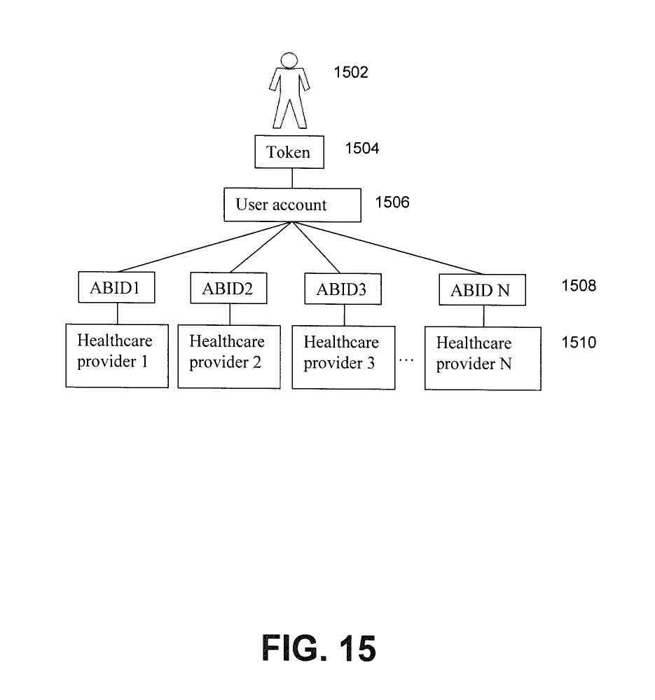

FIG. 15 illustrates the use of a token to provide access to a single user account by a plurality of healthcare providers, under an embodiment. As shown in FIG. 15, a user 1502 is assigned a token 1504, which is an alphanumeric key that allows access to his or her user account 1506. The user account 1506 may comprise at least part of the HIS/CIS information of the user and may be stored as part of the PHR database 228 of FIG. 2. It is assumed that each individual healthcare provider 1510 has and maintains an individual relationship with the user 1502, and maintains certain III information for the patient. This III information may be stored in a database maintained directly by each provider, such as patient database 224. Each healthcare provider can use their corresponding ABID 1508 to correlate the PHR information with the III information for the user, thus allowing the PHR user account to be accessed by different healthcare providers 1510 through the ABID 1508 mechanism as described above.

As shown in FIG. 15, the user account 1506 is accessed through a token 1502. In an embodiment, the token is an alphanumeric string of a defined length, and may represent an encoded value relating to the user. The token may be generated according to a defined format. For example, the token may be a 36-bit number that includes a country code for the user and certain other numbers, such as a serial number and check number. In this case, the format of the token may be a three-field alphanumeric that encodes information representing the user, such as: country abbr.+serial number+check number. In a 36-bit number, this may be represented, for example as: ZZ000000001W. It should be noted that the token can be formulated in any practical format or length, depending on the constraints and requirements of the system. At least a portion of the token, such as the serial number or check number, may be generated by a random number generation system.

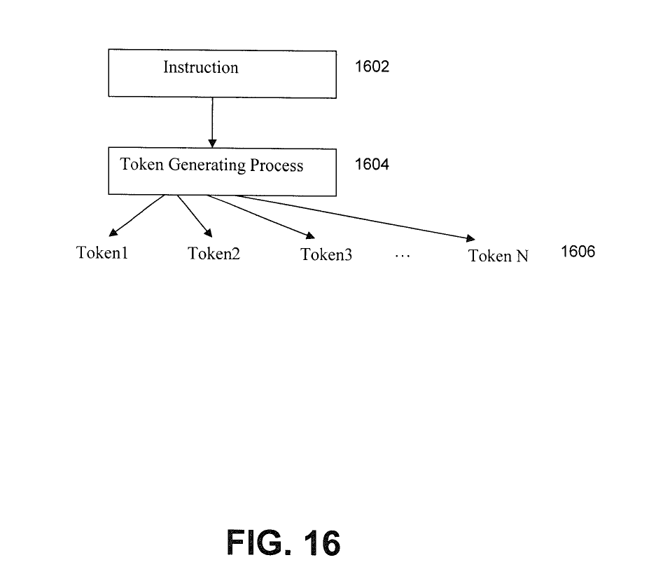

In an embodiment, the token for each user is generated through a token generation process that takes certain input and generates a unique token for each user. FIG. 16 illustrates a token generation process, under an embodiment. As shown in FIG. 16, an instruction string 1602 for the token is input to the token generating process 1604. The instruction string comprises a request or command from the user. The token generation process receives the instruction 1602 or a signal corresponding to the instruction 1602 and generates a token in response to the instruction. The token generating means 1604 may be a process or program that transforms this input instruction information into the alphanumeric token string. The process 1604 may be implemented as a proprietary program or function provided by a standard software program, such as MS Excel, for example. The token generating process 1604 generates a number of tokens 1606, by transforming the instruction string data and outputting an alphanumeric string. This string embodies a number code for each individual token 1 to N.

In an embodiment, the tokens are generated by a service provider associated with the data transmission service in system 100 of FIG. 1. This eliminates the need for the user and/or service provider to generate the tokens, and ensures that a neutral and robustly controlled entity is responsible for generating the tokens. In an example implementation, the Internet Service Provider (ISP) generates the tokens and maintains and executes the token generation process 1604 of FIG. 16.

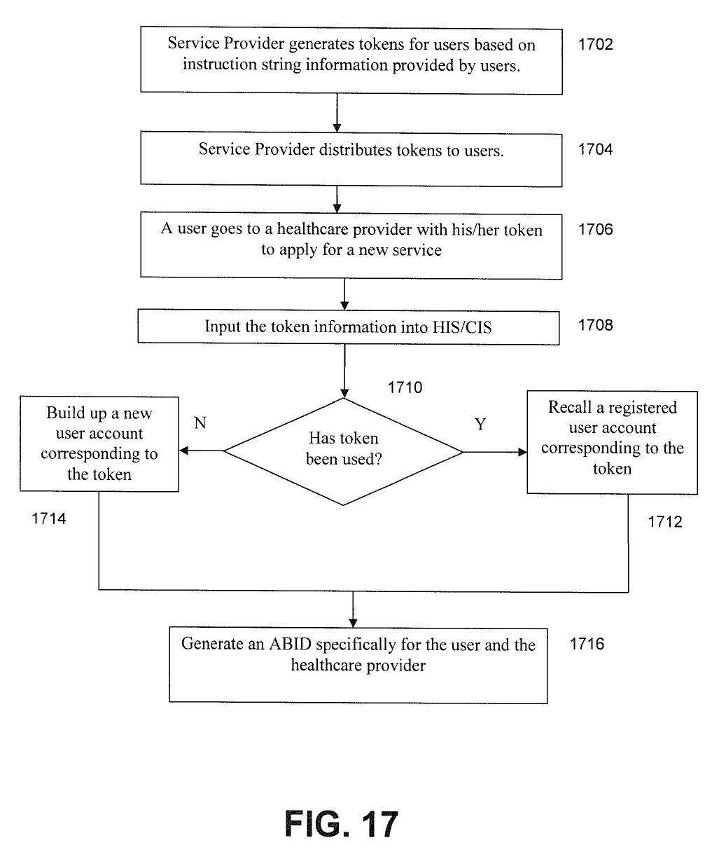

FIG. 17 is a flowchart illustrating the use of a token to generate an ABID for a user in relation with a healthcare provider, under an embodiment. In step 1702, the service provider (e.g., an ISP) generates tokens for one or more users based on the instruction string information provided by the users. The instruction string can be any suitable set of data elements, such as location information, identification information, and random or sequential numbers that is processed by the token generation process. The generated tokens are then distributed to the user or users, step 1704. This distribution may be accomplished through a secure transmission using a protocol established between the user and service provider. Alternatively, a subscription service may be set up between the service provider and users to request and receive tokens as required.

With the token, the user then approaches the healthcare provider to apply for a new service or care session, step 1706. The service provider then enters the user provided token into the HIS/CIS or PHR database 228, step 1708. In an embodiment, the HIS/CIS database is configured to recognize and process tokens to generate the ABID keys for use in the re-identification and indexing process between the III and de-identified data for the user.

When the token is input into the HIS/CIS database, a verification process checks to see whether or not the token has been used before or is a new token, step 1710. If the token is not new, the token is used to access and recall the registered user account corresponding to the token, step 1712. The process then proceeds with the generation of the ABID specifically for the user and the healthcare provider, step 1716, and as described previously in the present detailed description. If, in step 1710, it is determined that the token has not previously been used and is new, the system builds a new user account for the user, step 1714. This step involves registering the user and setting up a user account containing certain information regarding the user. Once the new user account is established, the ABID is then generated for the user, step 1716.

Embodiments have been described with respect to a computer-implemented method of providing a restricted access database containing de-identified user information for use by a service provider, wherein the method comprises:

Although embodiments have been described with respect to health industry applications in which the care provider is a physician, the user is a patient, and the patient data comprises health related PHR or PHD/I information, it should be understood that the embodiments are applicable to any system in which any type of private data of an individual is stored for use by a third party, such as financial management, fitness training, diet management, and the like.

Aspects of the de-identified database structure described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: microcontrollers with memory (such as EEPROM), embedded microprocessors, firmware, software, etc. Furthermore, aspects of the content serving method may be embodied in microprocessors having software-based circuit emulation, discrete logic (sequential and combinatorial), custom devices, fuzzy (neural) logic, quantum devices, and hybrids of any of the above device types.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the de-identified database structure is not intended to be exhaustive or to limit the embodiments to the precise form or instructions disclosed. While specific embodiments of, and examples for, processes in Internet search engines are described herein for illustrative purposes, various equivalent modifications are possible within the scope of the disclosed methods and structures, as those skilled in the relevant art will recognize.

The elements and acts of the various embodiments described above can be combined to provide further embodiments. These and other changes can be made to the web page optimization method in light of the above detailed description.

In general, in the following claims, the terms used should not be construed to limit the disclosed method to the specific embodiments disclosed in the specification and the claims, but should be construed to include all operations or processes that operate under the claims. Accordingly, the disclosed structures and methods are not limited by the disclosure, but instead the scope of the recited method is to be determined entirely by the claims. While certain aspects of the disclosed system and method are presented below in certain claim forms, the inventors contemplate the various aspects of the methodology in any number of claim forms. For example, while only one aspect may be recited as embodied in machine-readable medium, other aspects may likewise be embodied in machine-readable medium. Accordingly, the inventors reserve the right to add additional claims after filing the application to pursue such additional claim forms for other aspects

What is claimed is:

1. A computer-implemented method of providing a restricted access database containing de-identified user information for use by a service provider, comprising:
providing a user account containing limited identification information for a user accessing services provided by a plurality of service providers;
receiving instruction string information from the user to generate an alphanumeric token allowing access to the user account;
distributing the generated token to the user through a communication service provider system;
registering each authorized service provider of the plurality of service providers by setting up a service provider account and receiving authorization from the user for the service provider to provide the service to the user;
providing an access identifier and password to each authorized service provider of the plurality of service providers, to access the user account through the generated token;
generating an alliance based identification key specifically for the user and the user account, and containing service provider identification information and alliance identification information within a unitary data string;
storing the user individual identification information in an electronic record data table that is indexed by the alliance based identification key; and
storing the information related to services provided to the user in a personal record database that is indexed by the alliance based identification key, wherein the personal record database includes de-identified user information that does not contain any user individual identification information.

2. The method of claim 1 wherein the user individual identification information comprises user identification, name, birthdate, home address, telephone number, photographic data, and optionally user social security number and family relationship information.

3. The method of claim 2 wherein the service provider identification information comprises a provider identification code, a nationality code, a location code, and an institutional affiliation code.

4. The method of claim 3 further comprising:
automatically generating a unique identification number for the alliance between the user and the service provider, wherein the unique identification number is serialized by the provider identifier; and
combining the unique identification number and the provider information and storing as the alliance based identification key in the form of a unitary data string.

5. The method of claim 4 further comprising:
a user portal website comprising a first plurality of web pages providing information relating to counseling aspects of the service, and a basic search engine for searching the website;
registering an authorized user of the user portal website by setting up the user account and receiving information related to services provided to the user;
a provider portal website comprising a second plurality of web pages relating to management and care provider aspects of the service, and an advanced search engine for searching the website and authorized users of the website; and
storing the alliance based identification key in a provider portal website.

6. The method of claim 5 further comprising:
receiving a request through a query input to the advanced search engine on the provider portal website from an authorized service provider to access the user account and the information related to services provided to the user;
validating the authorized service provider by a first network protocol;
searching for de-identified user information in the personal record database that is response to the query using the alliance based identification key; and
displaying the responsive de-identified user information in the service provider portal.

7. The method of claim 1 wherein the service provider comprises a healthcare provider, and the user information comprises medical health records and information.

8. The method of claim 1 wherein the service provider comprises a financial services provider, and the user information comprises personal financial records and information.

9. The method of claim 1 wherein the service provider comprises a home energy usage or saving consultant, and the user information comprises home energy usage or saving information.

10. A system for storing and managing de-identified electronic health records comprising:
a plurality of physician portal websites running on a client computer operated by an physician, each physician portal website including an advanced search engine to request personal health records of one or more patients, and wherein each physician is authorized to provide medical services to the one or more patients through an authorization process;
an electronic health record database storing health record information for a plurality of patients, wherein the health record information comprises de-identified user information that does not contain any individual identification information for the one or more patients;
a patient identification datastore that is separate from the electronic health record database and storing individual identification information for the one or more patients in a physician's personal computer or portable memory device; and
an alliance based identification (ABID) key generation process creating an ABID-indexed personal health data account for each patient in the electronic health record database and for each physician, wherein the ABID key includes a physician identification information and a serial number uniquely generate for the alliance between the physician and the respective patient, wherein the ABID key is generated from a user account accessed by a token that allows access to the user account separately by each of the physicians.

11. The system of claim 10 further comprising a patient portal website running on a client computer operated by an authorized patient, the patient portal website including a basic search engine to request information relating to health care relevant to the authorized patient.

12. The system of claim 11 wherein the authorization process comprises receiving authorization from the patient for the service provider to provide the service to each respective patient through an in-person visit between the service provider and each of the one or more patients.

13. The system of claim 12 wherein the physician identification information comprises a physician identification code, a nationality code, a location code, and an institutional affiliation code.

14. The system of claim 13 wherein the individual identification information for the one or more patients comprises user name, birthdate, home address, telephone number, photographic data, and optionally user social security number and family relationship information.

15. The system of claim 11 further comprising a physician website configured to:
receive a request through a query input to the advanced search engine by the authorized physician to access a patient account;
validate the physician as an authorized physician by a first network protocol;
search for de-identified patient information in the electronic health record database that is response to the query using the alliance based identification key; and
display the responsive de-identified patient information through the physician website.

16. The system of claim 15 further comprising a file generation process configured to generate a composite file including the physician identification information and the ABID key appended with the patient individual identification information.

17. The system of claim 16 wherein the composite file comprises combination text file and markup language file.

18. The system of claim 17 wherein the composite file is indexed through the ABID key through the uniquely generated alliance serial number, and allows the authorized physician to view and modify patient information stored in the electronic health record database in a manner that identifies the patient information as belonging to a particular patient.

19. The system of claim 17 wherein the composite file is indexed through the ABID key through the uniquely generated alliance serial number, and allows only limited viewing of patient information by unauthorized individuals and that de-identifies any accessed information in the electronic health record database.

20. The system of claim 18 wherein the composite file is generated, and the responsive de-identified patient information through the physician website only during a single web browsing session of the physician on the physician client computer.

21. The system of claim 20 wherein the physician client computer includes a re-identification process operable to associate de-identified patient information with respective patient individual identification information based on the ABID key.

22. The system of claim 20 wherein the physician client computer includes a web server process and database server process that stores the composite file for response to requests from an electronic health record server for re-identification of associated de-identified patient information with respective patient individual identification information, based on the ABID key.

23. The system of claim 20 wherein the physician client computer comprises a networked apparatus that includes an auto-run re-identification process operable to associate de-identified patient information with respective patient individual identification information based on the ABID key.
